(19) United States
(12) Patent Application Publication
(10) Pub. No.: US 2008/0089815 A1
(43) Pub. Date: Apr. 17, 2008

(54) APPARATUS FOR MAINTAINING FRESHNESS BY APPLYING DISPLACEMENT CURRENT

(75) Inventors: Wan Taek HAN, Hwaseong-si (KR); Jeong Je PARK, Dong-gu (KR); Jae Chan PARK, Yongin-si (KR); Kyung Il CHO, Seoul (KR); Soo Bong HEO, Yongin-si (KR); Yun Woo NAM, Yongin-si (KR); Min Sun KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/828,564

(22) Filed: Jul. 26, 2007

(30) Foreign Application Priority Data
Oct. 12, 2006 (KR) 10-2006-0099336

(51) Int. Cl. B01J 19/08

(52) U.S. Cl. 422/186.04

(57) ABSTRACT

The present invention relates to an apparatus for maintaining freshness by applying a displacement current. Application of the displacement current to an object of preservation interrupts an ion channel of a living microorganism present in the object of preservation, thereby preventing the microorganism from proliferating and subsequently maintaining the freshness of the object of preservation. The apparatus for maintaining freshness by applying a displacement current includes: a displacement current control unit which regulates the displacement current at less than 1 A and less than 3 GHz; and a displacement current applying unit, comprising a first electrode, and a second electrode which faces the first electrode.

### CROSS-REFERENCE TO RELATED APPLICATION

This application claims priority under 35 U.S.C. § 119(a) to Korean Patent Application No. 10-2006-0099336, filed on Oct. 12, 2006, in the Korean Intellectual Property Office, the entire contents of which are hereby incorporated by reference.

### BACKGROUND OF THE INVENTION

1. Field of the Invention

The present invention relates to an apparatus for maintaining freshness by applying a displacement current, and more particularly, to an apparatus which applies the displacement current to an object of preservation, such that the current disrupts an ion channel of a living microorganism present in the object of preservation, thereby maintaining the freshness of the object of preservation.

2. Description of Related Art

Chemical methods such as heating, or the addition of food preservatives, are generally used for maintaining the freshness of an object of preservation such as foodstuffs or meats. However, heating an object of preservation results in the destruction of nutrients, chemical changes in the ingredients and a loss of flavor. Also, in many instances, the addition of food preservatives is prohibited.

Accordingly, various non-chemical methods for preservation are currently being developed. A non-chemical method for preservation used in the prior art, involves the application of a strong electric field to an object of preservation by applying a high voltage.

FIG. 1 is a diagram illustrating a configuration of a prior art preservation apparatus for maintaining freshness comprising a strong electric field.

Referring to FIG. 1, the prior art preservation apparatus comprising a strong electric field includes a power unit, which is not illustrated, and an electrode unit. The power unit is used for supplying a high voltage. The electrode unit includes a first electrode 110 and a second electrode 120, in order to form an electric field 130, which is formed by the high voltage. An object of preservation 100 is positioned between the first electrode 110 and the second electrode 120. The cell wall of a microorganism present in the object of preservation 100, is destroyed by the electric field 130. As a result, ion channels within the membrane of the microorganism are disrupted, resulting in an electrochemical imbalance of the cell membrane, thereby hindering the function of the cell. Accordingly, the proliferation of the microorganism may be prevented and the freshness of the object of preservation 100 may be maintained.

There are several limitations in using a prior art preservation apparatus comprising a strong electric field. First, the application of a high voltage is desirable to prevent the germ or microorganism from proliferating. Consequently, there are significant safety concerns associated with the use of the high voltage. Second, by applying the high voltage, there is a significant level of power consumption by the preservation apparatus. Third, the cost of production and the size of the preservation apparatus may be significant due to the power unit utilized for supplying the high voltage. Fourth, although a high voltage is applied to the electrode unit, when the electric current flowing through a conducting wire is not greater than a predetermined strength, the freshness of the object of preservation 100 may not be maintained.

### BRIEF SUMMARY

In one embodiment, an apparatus is provided for maintaining freshness by applying a displacement current, which may effectively maintain the freshness of an object of preservation, as opposed to applying a high voltage.

In another embodiment, an apparatus is provided for maintaining freshness by applying a displacement current with a low level of power consumption.

In yet another embodiment, an apparatus is provided for maintaining freshness by applying a displacement current, which prevents a microorganism from proliferating. The apparatus thereby may be relatively small in size, may effectively maintain the freshness of an object of preservation, and may have a low cost of production.

According to another embodiment, there is provided an apparatus for maintaining freshness by applying a displacement current, wherein the apparatus comprises: a displacement current control unit which regulates the displacement current at less than 1 A amplitude and less than 3 GHz; and a displacement current applying unit comprising a first electrode, and a second electrode which faces the first electrode.

A displacement current is a current that flows in a dielectric substance according to the displacement of an external electric field. In cases where the dielectric substance is between two electrodes, like a condenser, when an alternating current is applied to the electrodes, the conduction current flows through an external conducting wire, although the conduction current does not flow within the dielectric substance. However, in the apparatus described herein, it is considered that the current flows in the dielectric substance, and it is this current that corresponds to the displacement current. The apparatus for maintaining freshness by applying a displacement current, acts by applying the displacement current to an object of preservation, disrupting an ion channel in a microorganism present in the object of preservation, preventing the microorganism from proliferating, and thereby maintaining the freshness of the object of preservation.

Additional and/or other aspects and advantages will be set forth in part in the description which follows.

### BRIEF DESCRIPTION OF THE DRAWINGS

The above and/or other aspects and advantages will become apparent and more readily appreciated from the following detailed description, taken in conjunction with the accompanying drawings of which:

FIG. 1 is a diagram illustrating a prior art configuration of an apparatus for maintaining freshness using a strong electric field;

FIG. 2 is an exemplary depiction illustrating components of an apparatus for maintaining freshness by applying a displacement current according to an embodiment described herein;

FIG. 3 is an exemplary depiction illustrating an apparatus for maintaining freshness by applying a displacement current according to an embodiment described herein;

FIG. 4 is an exemplary depiction illustrating an apparatus for maintaining freshness by applying a displacement current with a multiple electrode structure according to an embodiment described herein;

FIG. 5 is an exemplary depiction illustrating components of a displacement current control unit according to an embodiment described herein;

FIGS. 6A, 6B, 6C, 6D, and 6E are graphs illustrating a waveform of a displacement current, which may be stored in a waveform storing unit of a displacement current control unit;

FIGS. 7A, 7B, and 7C are graphs illustrating a waveform of a displacement current which is time-scaled, and amplitude-scaled, via a displacement current control unit;

FIGS. 8A, 8B, and 8C are graphs illustrating a displacement current where a frequency, i.e. cyclic period, is converted via a conversion unit of a displacement current control unit; and

FIGS. 9A and 9B are graphs illustrating a simulation result comparing the size of an induced displacement current according to a voltage application of sine wave and square wave.

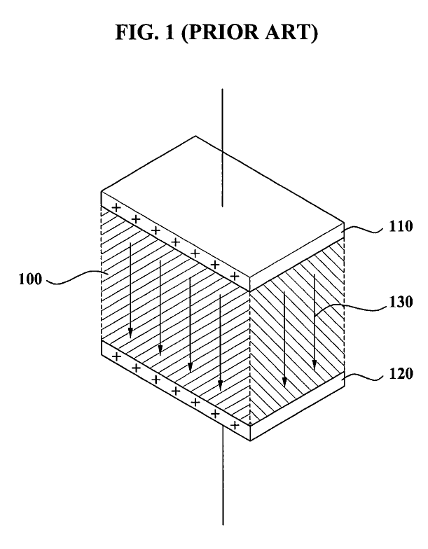

### DETAILED DESCRIPTION OF THE EMBODIMENTS

Hereinafter various embodiments of will be explained in more detail with reference to the accompanying drawings, wherein like reference numerals refer to the like elements throughout.

It will be understood that when an element or layer is referred to as being “on,” “interposed,” “disposed,” or “between” another element or layer, it can be directly on, interposed, disposed, or between the other element or layer or intervening elements or layers may be present.

It will be understood that, although the terms first, second, third, and the like may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, first element, component, region, layer or section discussed below could be termed second element, component, region, layer or section without departing from the teachings of the present invention.

As used herein, the singular forms “a,” “an” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to one embodiment, the apparatus for maintaining freshness by applying a displacement current includes a displacement current control unit and a displacement current applying unit.

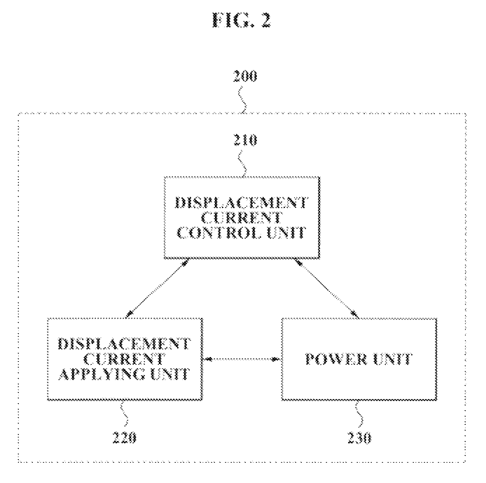

FIG. 2 is an exemplary depiction illustrating the components of an apparatus for maintaining freshness by applying a displacement current. The displacement current control unit 210 regulates the displacement current at less than 1 A and 3 GHz. Specifically, the displacement current control unit 210 stores a predetermined waveform to enable the displacement current having the predetermined waveform to be outputted. The displacement current control unit 210 also controls the size of the amplitude or frequency of the displacement current. In addition, the displacement current control unit 210 sets and controls an offset of the waveform, and sets the offset of the waveform of the displacement current according to the object of preservation. Thus, the freshness of the object of preservation may be maintained more efficiently.

According to another embodiment, the displacement current applying unit 220 includes a first electrode, and a second electrode, which faces the first electrode. The object of preservation is positioned between the first electrode and the second electrode. In a preferred embodiment, the displacement current applying unit 220 may include a plurality of first electrodes and a plurality of second electrodes, wherein the plurality of first and second electrodes may form a polyhedral structure. Also, any one of the first electrode and the second electrode may be an electrode that is in the form of plate, and surrounded by a dielectric substance. The electrode generally comprises a conductive material. The conductive materials may comprise metals, electrically conductive metal oxides or electrically conducting polymers. Examples of suitable metals are gold (Au), silver (Ag), nickel (Ni), chromium (Cr), copper (Cu), or the like, or a combination comprising at least one of the foregoing. Examples of suitable electrically conducting metal oxides are tin oxide, antimony tin oxide, indium tin oxide (ITO), or the like, or a combination comprising at least one of the foregoing metal oxides. Examples of suitable conducting polymers are polypyrrole, polythiophene, polyaniline, polyacetylene, or the like, or a combination comprising at least one of the foregoing metal oxides.

According to yet another embodiment, the apparatus for maintaining freshness by applying a displacement current may further include a power unit 230 to supply a voltage for generating the displacement current, to the displacement current control unit 210.

The power unit 230 may supply the voltage in the form of any one of the group consisting of a pulse voltage, an alternating current voltage, a direct current voltage, or a combination comprising at least one of the forgoing voltages. The power unit 230 also supplies the power for generating the displacement current. The displacement current has less than 1 A and less than 3 GHz of a predetermined waveform between the first electrode and the second electrode.

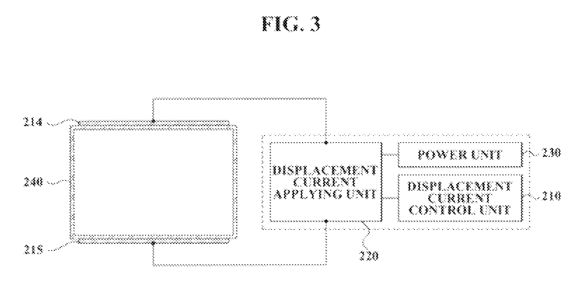

In one embodiment, the present invention includes a displacement current control unit 210 and a displacement current applying unit 220. FIG. 3 is an exemplary depiction illustrating an apparatus for maintaining freshness by applying a dielectric current. In FIG. 3, the apparatus for maintaining freshness by applying a displacement current may further include a power unit 230 to supply a voltage for generating a displacement current, to the displacement current control unit 210. In this instance, the displacement current control unit 210 regulates the displacement current at a predetermined amplitude and frequency, and the displacement current applying unit 220, comprises a first electrode 214, and a second electrode 215 which faces the first electrode 214.

The first electrode 214, or the second electrode 215, may be an electrode, which is in the form of plate, and surrounded by a dielectric substance. The plate can be manufactured from the conductive materials listed above.

In another embodiment, an object of preservation is positioned between the first electrode 214 and the second electrode 215, and the freshness of the object of preservation is maintained subsequent to the application of the displacement current. In a preferred embodiment, the apparatus for maintaining freshness by applying a displacement current may further include a housing member 240, which provides a space for the object of preservation. Also in FIG. 3, the power unit 230 may supply the voltage in the form of at least one of the group consisting of a pulse voltage, an alternating current voltage, a direct current voltage, and a combination comprising at least one of the foregoing types of voltages.

According to one embodiment of the present invention, the apparatus for maintaining freshness by applying a displacement current is not limited to the preservation of a liquid and may be used to preserve various types of objects of preservation such as vegetables, sweets, meats, or the like.

According to another embodiment of the present invention, an apparatus for maintaining freshness is provided, which has a low level of power consumption due to the application of a displacement current, as opposed to the application of a high voltage.

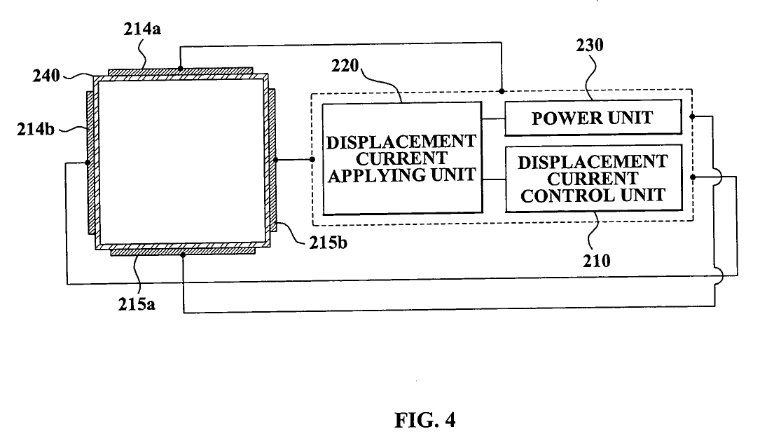

In one embodiment, an apparatus for maintaining freshness by applying a displacement current is provided which comprises a multiple electrode structure FIG. 4 is an exemplary depiction of such an apparatus.

Referring to FIG. 4, a displacement current applying unit 220 includes first electrodes 214a and 214b, and second electrodes 215a and 215b, which face the first electrodes 214a and 214b respectively. An object of preservation is positioned between the first electrodes 214a and 214b and the second electrodes 215a and 215b. The displacement current applying unit 220 may include a plurality of first electrodes 214a and 214b, and second electrodes 215a and 215b, wherein the plurality of first electrodes 214a and 214b and second electrodes 215a and 215b may form a polyhedral structure. The polyhedral structure comprising the first electrodes 214a and 214b and the second electrodes 215a and 215b provides a more efficient method for application of the displacement current, and thereby can maintain the freshness of the object of preservation more efficiently. Also, any one of the first electrodes 214a and 214b, and the second electrodes 215a and 215b, correspond to an electrode that is in the form of plate, and surrounded by a dielectric substance. The plate is comprised of any one of Au, Ag, Ni, Cr, Cu, Pt, Al, and ITO.

In another embodiment, the displacement current control unit comprises a waveform storing unit and a conversion unit.

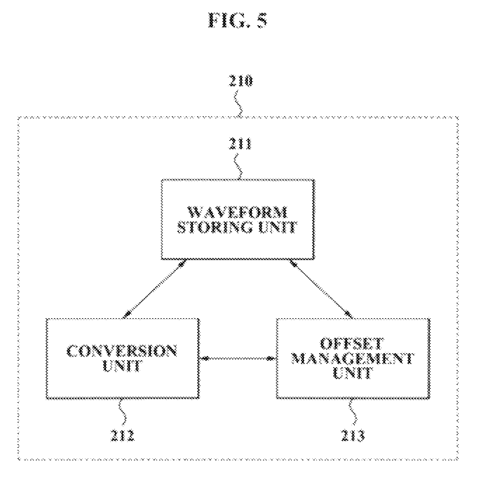

FIG. 5 is an exemplary depiction of the components of a displacement current control unit 210. The waveform storing unit 211 stores a predetermined waveform, which enables a displacement current having the predetermined waveform to be supplied. The conversion unit 212 controls the amplitude or frequency of the displacement current. The displacement current control unit 210 may further include an offset management unit 213. The offset management unit 213 sets and controls an offset of the waveform. The offset of the waveform of the displacement current is set as (+) or (−) by the offset management unit 213, according to the object of preservation. Accordingly, the freshness of the object of preservation may be maintained more efficiently.

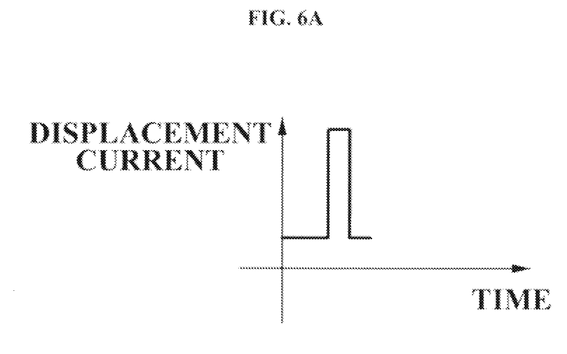

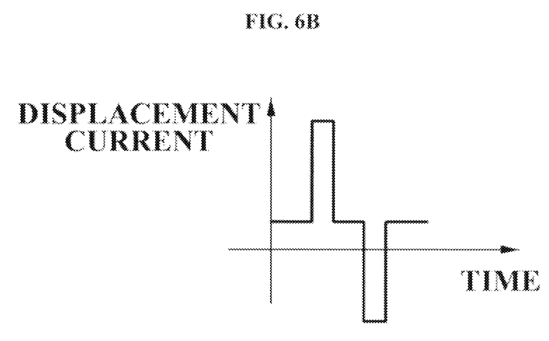

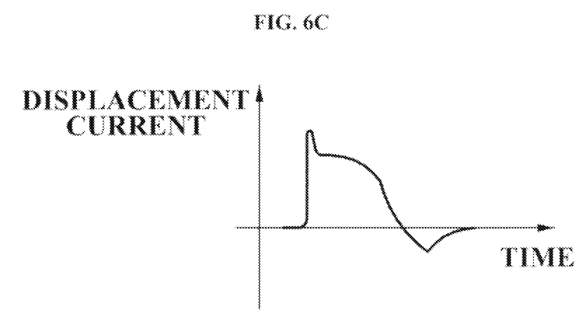

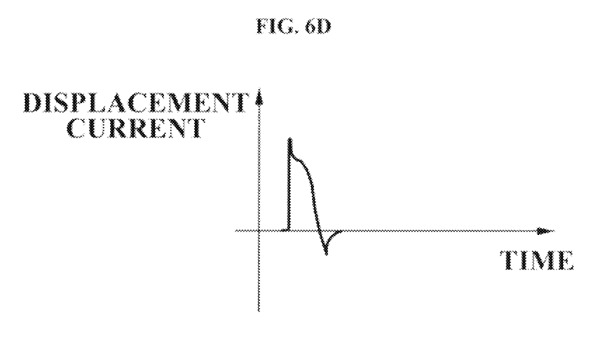

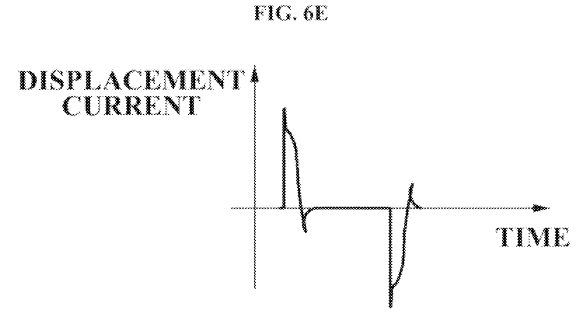

The displacement current, which has various types of waveforms, as determined by the waveform storing unit 211 and the conversion unit 212, will be described in detail with reference to FIGS. 6A through 6E, 7A through 7C, and 8A through 8C.

FIGS. 6A, 6B, 6C, 6D, and 6E are graphs illustrating a waveform of a displacement current, which may be stored in a waveform storing unit of a displacement current control unit as described herein. The waveform storing unit 211 may store various types of waveforms, and the conversion unit 212 outputs the displacement current that is required for optimally maintaining the freshness of the object of preservation. As illustrated in FIGS. 6A and 6B, a square wave is one of the various types of waveforms that may be utilized. In addition, a waveform combining the square wave and a sine wave, as illustrated in FIGS. 6C, 6D and 6E, may also be utilized as one of the various types of waveforms.

Through the various types of waveforms described above, the flow of ions within a microorganism may be controlled. Application of a displacement current comprising various types of waveforms, to an object of preservation, may produce an electrochemical imbalance within any microorganisms that are present in the object.

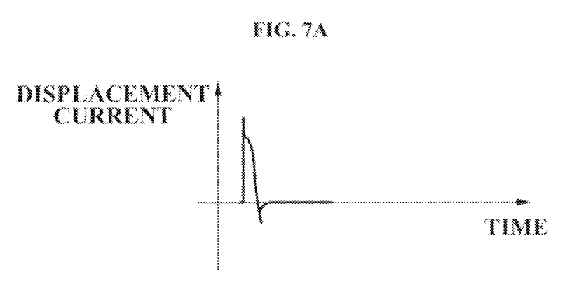

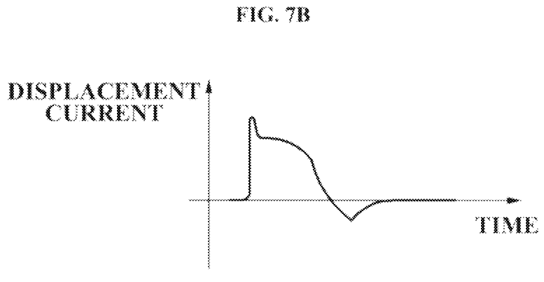

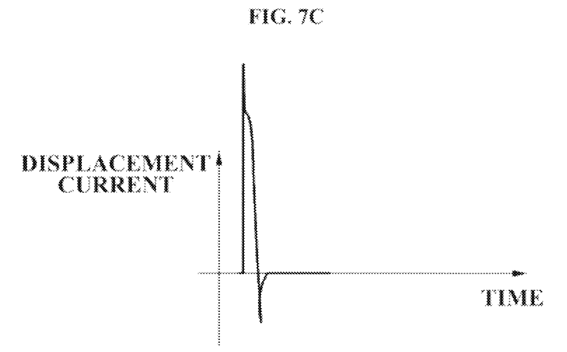

FIGS. 7A, 7B, and 7C are graphs illustrating a waveform of a displacement current, which is both time-scaled and amplitude-scaled via a displacement current control unit. Specifically, FIGS. 7B and 7C illustrate a waveform where the amplitude is scaled via a displacement current control unit 210. Waveforms where the amplitude is scaled, illustrated in FIGS. 7B and 7C, may be determined in a displacement current waveform which is generated earlier by a conversion unit 212, illustrated in FIG. 7A.

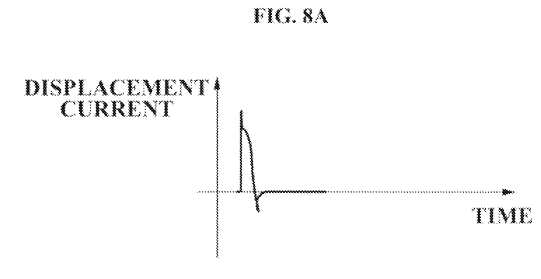

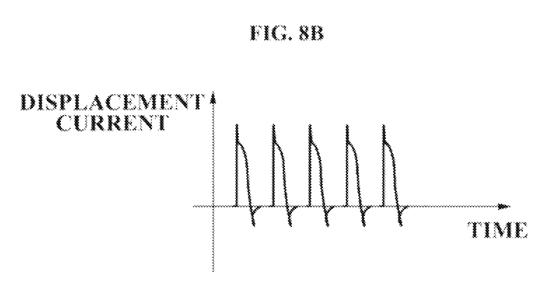

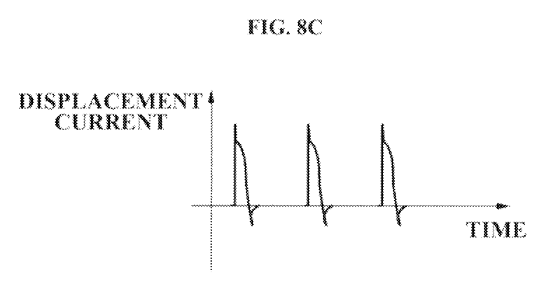

FIGS. 8A, 8B, and 8C are graphs illustrating a displacement current where the frequency, i.e. cyclic period, is converted via a conversion unit of a displacement current control unit. Waveforms where the frequency is converted, illustrated in FIGS. 8B and 8C, may be confirmed by a displacement current waveform which has been initially generated, illustrated in FIG. 8A.

The freshness of the object of preservation may be maintained through the application of a displacement current, using the displacement current control unit 210 as described above, as opposed to the application of a high voltage.

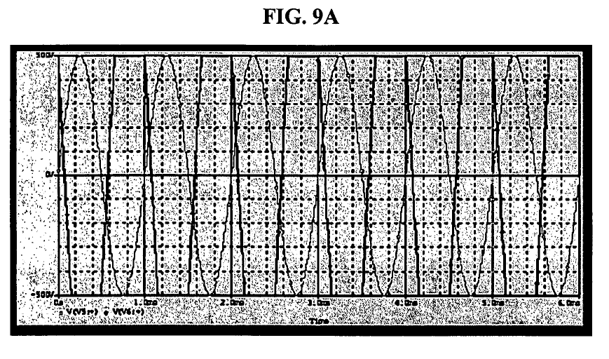

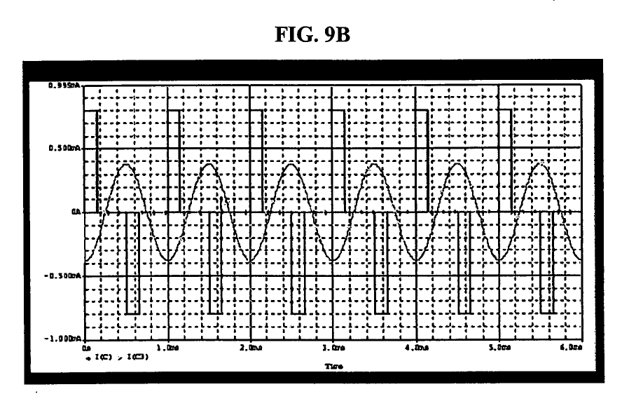

FIGS. 9A and 9B are graphs illustrating a simulation result comparing the size of an induced displacement current resulting from the voltage application of a sine wave and the voltage application of a square wave.

The application of a voltage in a sine wave and a voltage in a square wave, with identical frequency and amplitude (FIG. 9A), to an apparatus for maintaining freshness (illustrated in FIG. 3), results in the induction of a displacement current between the first electrode 214 and the second electrode 215. FIG. 9B illustrates the displacement currents generated by the two types of voltage waves. In this instance, results for the sine wave are illustrated in blue, and results for the square wave are illustrated in green.

In FIG. 9B, the size of the induced displacement current resulting from the application of a voltage in a sine wave is approximately two times greater than the size of an induced displacement current resulting from the application of a voltage in a square wave. When applying a displacement current of a sine wave and a displacement current of a square wave, to the apparatus for maintaining freshness, the effect on the freshness maintenance of the object of preservation, may be proportional to the size of the induced displacement current. In accordance with one embodiment, it is preferable that the displacement current of a square wave be applied to the apparatus for maintaining freshness.

According to one embodiment, an apparatus for maintaining freshness by applying a displacement current may effectively maintain the freshness of an object of preservation by the application of a displacement current.

According to another embodiment, an apparatus for maintaining freshness by applying a displacement current may maintain the freshness of an object of preservation while maintaining a low level of power consumption.

According to yet another embodiment, an apparatus for maintaining freshness by applying a displacement current may prevent a microorganism from proliferating by applying the displacement current, may be small in size, may effectively maintain the freshness of object of preservation, and may have a low cost of production.

Although the preferred embodiments of the present invention have been disclosed for illustrative purposes, the present invention is not limited hereto. Instead, those skilled in the art will appreciate that various modifications, additions, or substitutions are possible without departing from the scope, principles, and spirit of the invention as disclosed and claimed in the accompanying claims.

What is claimed is:

1. An apparatus for maintaining freshness by applying a displacement current wherein the apparatus comprises:
a displacement current control unit; and
a displacement current applying unit.

2. The apparatus of claim 1, wherein the displacement current control unit regulates the displacement current at less than 1 A and less than 3 GHz.

3. The apparatus of claim 1, wherein the displacement current applying unit comprises:
a first electrode; and
a second electrode which faces the first electrode.

4. The apparatus of claim 1, further comprising:
a power unit which supplies a voltage for generating the displacement current to the displacement current control unit.

5. The apparatus of claim 4, wherein the power unit supplies the voltage in the form of at least one of the group consisting of a pulse voltage, an alternating current voltage, a direct current voltage, and a combination comprising at least one of the foregoing voltages.

6. The apparatus of claim 1, wherein the displacement current control unit comprises:
a waveform storing unit; and
a conversion unit.

7. The apparatus of claim 6, wherein the waveform storing unit stores a predetermined waveform which enables the displacement current having the predetermined waveform to be outputted.

8. The apparatus of claim 6, wherein the conversion unit controls an amplitude and/or a frequency of the displacement current.

9. The apparatus of claim 6, wherein the displacement current control unit further comprises an offset management unit, which sets and controls an offset of the waveform.

10. The apparatus of claim 6, wherein the waveform is selected from the group consisting of a sine wave, a square wave, and a combination of the sine wave and the square wave.

11. The apparatus of claim 3, wherein the displacement current applying unit comprises a plurality of first electrodes and a plurality of second electrodes, wherein the plurality of the first electrodes and the plurality of the second electrodes form a polyhedral structure.

12. The apparatus of claim 3, wherein the first electrode and the second electrode corresponds to an electrode which is in a form of plate and comprises an electrically conducting material.

13. The apparatus of claim 3, wherein the electrically conducting material is a metal, an electrically conducting metal oxide, an electrically conducting polymer, or a combination comprising at least one of the foregoing electrically conducting materials.
